(19) United States
(12) Patent Application Publication
(10) Pub. No.: US 2006/0082693 A1
(43) Pub. Date: Apr. 20, 2006

(54) Bevel gradient dichroic film for liquid crystal on silicon display and method for testing the same

(76) Inventors: Cheng-Yu Huang, Jhongli City (TW); Yi-Wei Liu, Tucheng City (TW); Po-Liang Chiang, Taipei City (TW)

Correspondence Address: J.C. Patents, Suite 250, 4 Venture, Irvine, CA, 92618, US

(21) Appl. No.: 11/293,587

(22) Filed: Dec. 1, 2005

Related U.S. Application Data
(62) Division of application No. 10/818,990, filed on Apr. 5, 2004.

(51) Int. Cl. G02F 1/1335

(52) U.S. Cl. 349/5

(57) ABSTRACT

A bevel gradient dichroic film for an off-axis liquid crystal on silicon display device is provided. The bevel gradient dichroic film includes a dichroic film, the dichroic film having a film characteristic, and the film characteristic of the dichroic film including a gradient direction. The gradient direction is dependent on an incident angle of an incident light so that a light spot of the incident light on the dichroic film has a light characteristic being uniformly distributed.

### BACKGROUND OF THE INVENTION

1. Field of the Invention

This invention generally relates to a display, and more particularly to a liquid crystal on silicon display, a bevel gradient dichroic film for the same, and a method of testing the bevel gradient dichroic film, suitable for a off-axis projector system to improve the uniformity, brightness and contrast.

2. Description of the Related Art

Because the liquid crystal display (LCD) has the advantages of compact size, lightweight, low operational voltage, low power consumption, and radiation free, it has gradually replaced the conventional CRT display and became the main stream of the display devices. However, due to the limitation of manufacturing technology of LCD, the size of most LCD products is limited to below 30 inches. Although plasma display panel can provide a display size between 30-60 inches, most consumers cannot afford such products because of the high costs.

Hence, to provide affordable large size displays, most manufacturers adopt the projection technology such as reflective projection display devices and rear projection display devices. The reflective projection display device includes the liquid crystal projector (LCP), the digital light protector (DLP), and the liquid crystal on silicon (LCOS) projection device. The rear projection display device also uses LCOS technology. Currently, the DLP and LCOS are the most adopted technologies in the market. Because the LCOS technology provides the advantages of low cost, high aperture ratio (can be as high as 90%), high resolution (the pixel distance can be 12 um or less), more and more manufacturers have been developing this technology.

Therefore, the LCOS projection technology is the key technology for the reflective projection display devices and the rear projection display devices because it can significantly reduce the cost and increase the resolution.

FIG. 1 is a schematic view illustrating a conventional LCOS projection device. Referring to FIG. 1, the operation principle of the LCOS will be illustrated as follows. The light source 102 emits the white light 104 and the white light 104 passes through the filter 106 and the color separation mirror 108 to obtain the red light 112, the green light 122, and the blue light 142. The red light 112 will reach the polarization beam splitter (PBS) 116 via the dichroic mirror 110 and the reflective mirror 114.

FIGS. 2A and 2B are schematic views illustrating the operation of the conventional PBS. For example, when the red light 112 goes through the PBS 116, the PBS 116 will polarize the red light 112 and reflect only the S-polarized red light to the LCOS panel 118. Referring to FIG. 2A, when the video signal is to be shown on the dark panel, the S-polarized red light will be reflected back and thus cannot enter into the X-cube 152. Referring to FIG. 2B, when the video signal is to be shown on the bright panel, the S-polarized red light will be converted into a P-polarized red light 120 by the LCOS panel so that the P-polarized red light 120 can enter into the X-cube 152.

Hence, the red light 112, the green light 122, and the blue light 142 are reflected to the LCOS panels 118, 132, and 146 via the PBS 116, 130, and 144 respectively. The red light 120, green light 134, and blue light 148 that are partially polarized by the LCOS panels will be combined by the X-cube 152 to generate the video signal. Finally, the video signal will be projected to the display via the zoom lens 154.

Hence, the color separation device (e.g., dichroic mirror) and recombination device (e.g., X-cube) are the most important devices for the conventional LCOS projection system. If the color separation or color recombination ratio between the red/green/blue light is not uniform, the uniformity and the brightness of the recombined video signal will be seriously affected. Further, if the recombined video signal is not in focus, the final video will be blurring and affects the resolution.

In the conventional LCOS projection system, the color separation device is X-cube, dichroic mirror, or dichroic filter. For example, the X-cube 110 in FIG. 1 can be a color separation mirror when the direction of the propagation of light is opposite. The dichroic mirror 110 shown in FIG. 1 uses the dichroic mirror or dichroic filter. Further, the light path and the normal direction of the reflective surface of the color separation device are parallel in the conventional LCOS projection system, which is so-called “on-axis” design. For example, the light path of the red light 112 is perpendicular to the reflective surface 162 of the PBS 116 and the reflective surface 164 of the X-cube 152.

FIG. 3A is a top view of the on-axis design of the conventional dichroic mirror. FIG. 3B is a cross-sectional view of the dichroic mirror from the direction of A of FIG. 3A. FIG. 3C is a cross-sectional view of the light spot taken along the line B-B of FIG. 3A. Referring to FIG. 3B, the light 302 perpendicularly emits on the reflective surface 304 of the dichroic mirror 304. Referring to FIG. 3C, the light spot 312 of the light 302 on the reflective surface 306 has an ellipse shape. Generally, this on-axis design can provide a light spot 312 with good color uniformity.

When a better color uniformity is required, a dielectric or metal film can be coated on the dichroic mirror or filter to change the characteristics of the light beam propagation due to the interference effect. For example, a special optical film can be coated on the dichroic mirror or filter to form a horizontal gradient coating dichroic mirror or a horizontal gradient coating dichroic filter. Hence, a more uniform primary color lights with a higher transparent ratio can be obtained from the incident light in order to generate a better recombined video signal.

FIG. 4 is a schematic drawing illustrating an off-axis LCOS projection device. The light source 402 emits the white light 402 and the dichroic mirror 404 separate the red light 406, the green light 408, and the blue light 410. Those primary color lights are polarized by the polarizer 412 and incident on the LCOS panel 414. The LCOS panel 414 then partially polarizes the red/green/blue lights. Then the analyzer 416 and the dichroic mirror 418 recombine the partially polarized red/green/blue lights to obtain the video signal. Then the video signal is projected to the display.

A concern for the off-axis LCOS projection device is that the distribution of the primary colors is not uniform. Even if the horizontal gradient coating dichroic mirror or the horizontal gradient coating dichroic filter is used in the off-axis LCOS projection device, the distribution of the primary colors is still not uniform. Therefore, how to improve the distribution of the primary colors and increase the contrast is a very important issue.

### SUMMARY OF THE INVENTION

An object of the present invention is to provide a bevel gradient dichroic film to effectively improve the distribution uniformity, brightness, and contrast of the primary color light beams.

Another object of the present invention is to provide a LCOS projection device with a bevel gradient dichroic film, in order to effectively improve the distribution uniformity, brightness, and contrast of the primary color light beams.

Still an object of the present invention is to provide a method for testing the bevel gradient dichroic film to obtain the distribution uniformity, brightness, and contrast of the primary color light beams.

As embodied and broadly described herein, the present invention provides a bevel gradient dichroic film for an off-axis liquid crystal on silicon display device. The bevel gradient dichroic film includes a dichroic film, the dichroic film having a film characteristic, the film characteristic of the dichroic film including a gradient direction. Wherein the gradient direction is dependent on an incident angle of an incident light so that a light spot of the incident light on the dichroic film has a light characteristic being uniformly distributed.

In a preferred embodiment of the present invention, the bevel gradient dichroic film includes a dielectric material or metal.

In a preferred embodiment of the present invention, the film characteristic includes a dielectric characteristic or a thickness of the film.

In a preferred embodiment of the present invention, the light characteristic of the light spot includes an energy distribution, a reflective index, or a light separation ratio for different color lights.

The present invention provides a liquid crystal on silicon display device which includes: a light source for emitting a white light; a color separation mirror for separating the white light into three primary color lights; a polarizer for polarizing the three primary color lights; a liquid crystal on silicon panel for partially polarizing the three primary color lights according to the video component of an input video signal; an analyzer; and a color recombination mirror. The analyzer and the color recombination mirror combine the partially polarized three primary color lights to obtain an output video signal. Wherein a bevel gradient dichroic film is formed on at least one of the color separation mirror and the color recombination mirror. The gradient dichroic film includes a dichroic film, the dichroic film having a film characteristic, the film characteristic of the dichroic film including a gradient direction. The gradient direction is dependent on an incident angle of an incident light so that a light spot of the incident light on the dichroic film has a light characteristic being uniformly distributed.

The present invention provides a method for testing a bevel gradient dichroic film. The method includes: providing an incident light having a plurality of incident angles to the bevel gradient dichroic film; and testing a light characteristic of a dichroic light beam separated from the incident light at each of the incident angles to determine whether the light characteristic is uniform.

In a preferred embodiment of the present invention, the light characteristic of the dichroic light beam includes an energy distribution, a reflective index, or a light separation ratio for different color lights.

Accordingly, in the bevel gradient dichroic film and the LCOS display device of the invention, the thickness gradient and characteristics of the dichroic film on the color separation mirror or color recombination mirror is dependent on the angle of the incident light. Accordingly, by adjusting the direction of the thickness gradient or characteristic of the coating film and the distribution of the thickness or the characteristic of the coating film, the distribution uniformity, brightness and contrast of the primary color light beams can be effectively improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a conventional LCOS projection device.

FIGS. 2A and 2B schematic views illustrating the operation of the conventional PBS.

FIG. 3A is a top view of the on-axis design of the conventional dichroic mirror.

FIG. 3B is a cross-sectional view of the dichroic mirror from the direction of A of FIG. 3A.

FIG. 3C is a cross-sectional view illustrating the light spot taken along the line B-B of FIG. 3A.

FIG. 4 is a schematic drawing illustrating an off-axis LCOS projection device.

FIG. 5A is a top view of the off-axis design of the dichroic mirror.

FIG. 5B is a cross-sectional view of the dichroic mirror viewed along the direction of C of FIG. 5A.

FIG. 5C is a cross-sectional view illustrating the light spot taken along the line D-D of FIG. 5A.

FIG. 6 is a cross-sectional view of a horizontal gradient coating dichroic mirror for the off-axis design.

FIG. 7 is a cross-sectional view of a bevel gradient coating dichroic mirror for the off-axis design according to an embodiment of the invention.

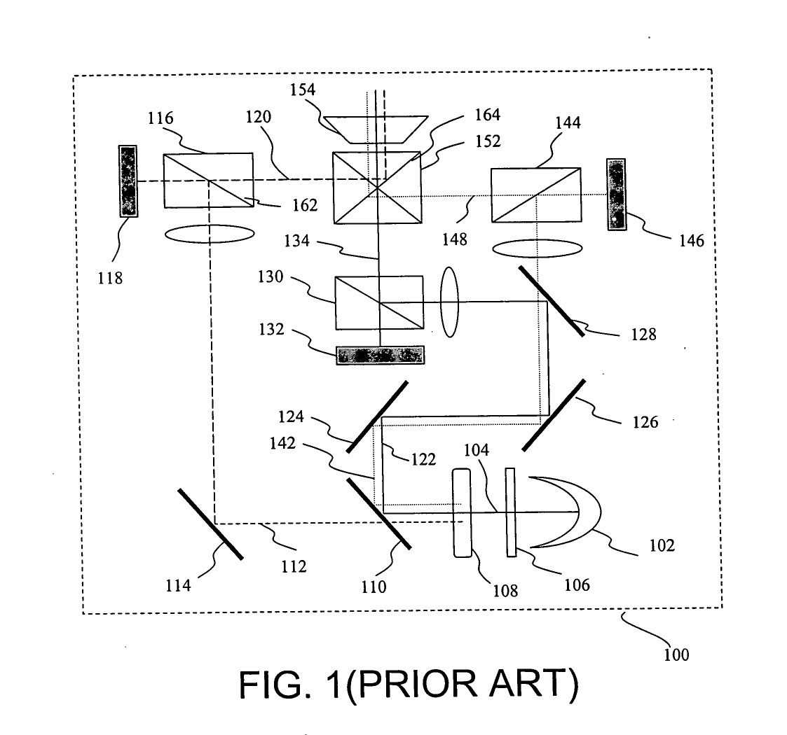

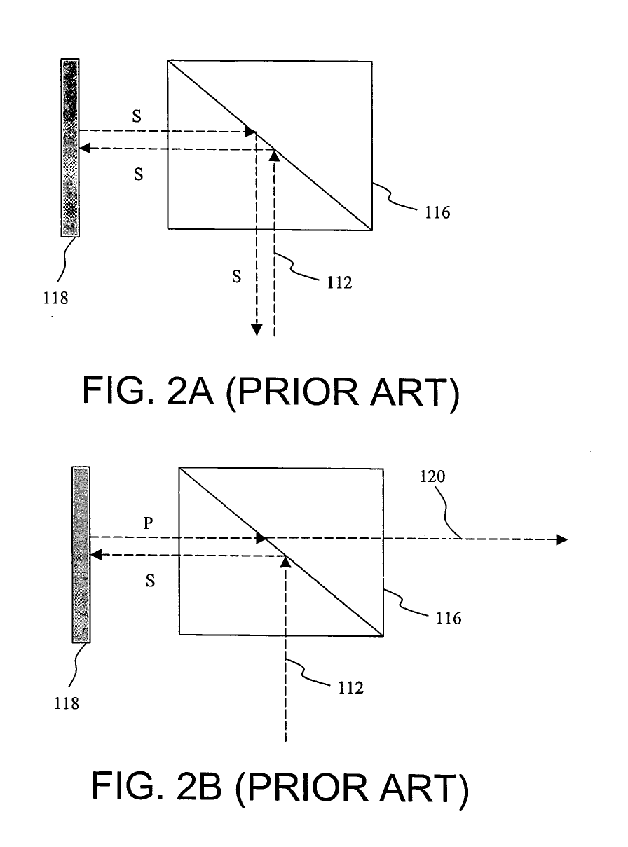

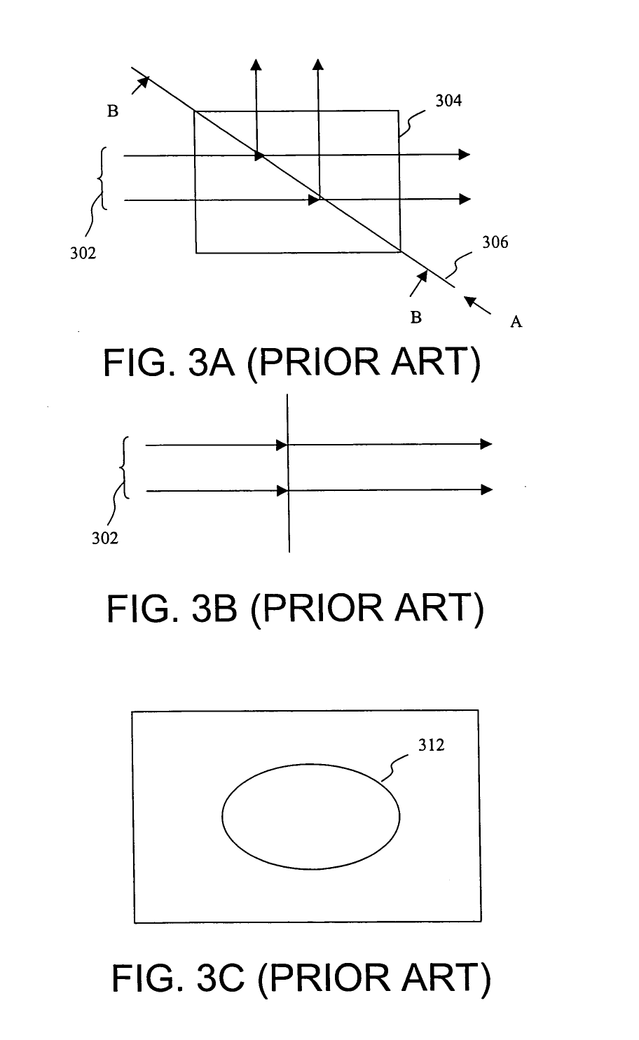

### DESCRIPTION OF THE PREFERRED EMBODIMENTS

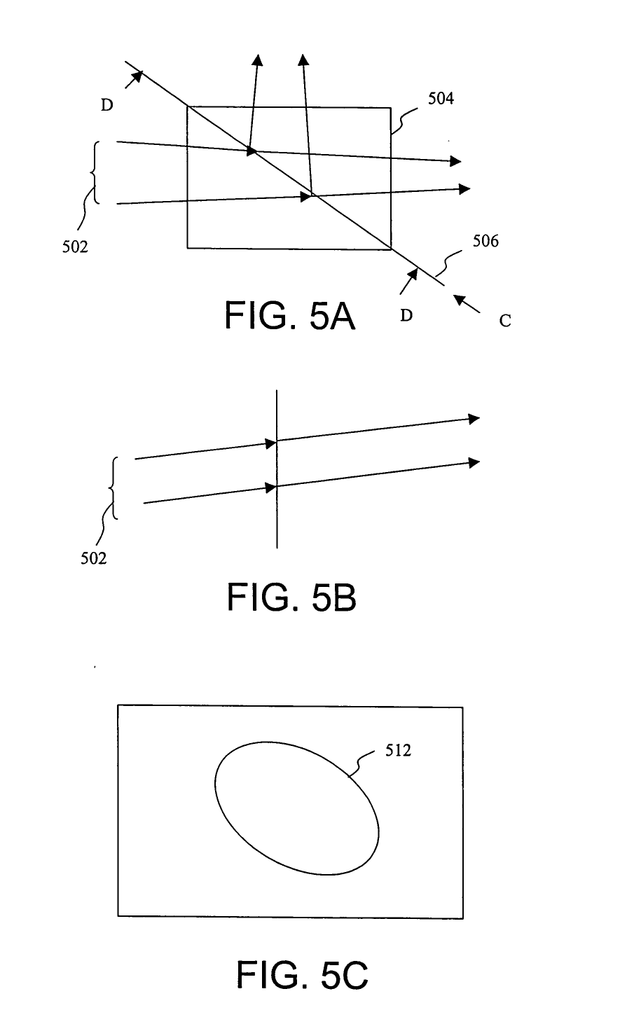

FIG. 5A is a top view of the off-axis design of the dichroic mirror. FIG. 5B is a cross-sectional view of the dichroic mirror viewed along the direction of C of FIG. 5A. FIG. 5C is a cross-sectional view illustrating the light spot taken along the line D-D line of FIG. 5A. Referring to FIG. 5B, the light 502 is not perpendicularly incident onto the reflective surface 506 of the beam splitter mirror 504, but is incident onto the reflective surface 506 at an angle with respect to the normal of the reflective surface 506. Referring to FIG. 5C, the light spot 512 of the light 502 on the reflective surface 506 has a bevel ellipse shape. Further, this off-axis design cannot provide a light spot 512 with good color uniformity.

For a better color uniformity, a dielectric or metal film can be coated on the dichroic mirror 504 to change the characteristics of the light beam propagation due to the interference effect. However, the coated dichroic mirror 504 can not be a horizontal gradient coating dichroic mirror but must be a bevel gradient coating dichroic mirror for the off-axis design.

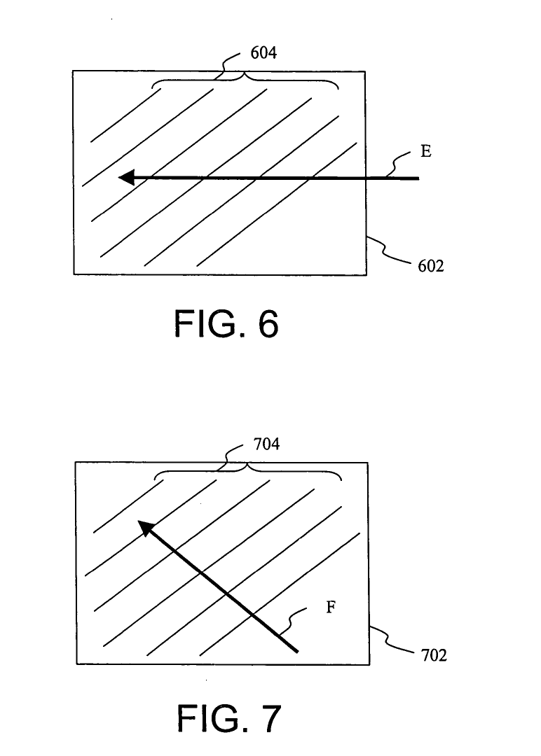

FIG. 6 is a cross-sectional view of a horizontal gradient coating dichroic mirror for the off-axis design. Referring to FIG. 6, the coating film on the reflective surface of the dichroic mirror has a variation in the thickness gradient in the direction of arrow E. For the horizontal gradient coating dichroic mirror, the arrow E is in the horizontal direction and the incident light with the same incident angle is in the direction of the lines 604. Hence, the direction of the incident light does not depend on the direction of arrow E (the direction of the variation in the thickness gradient). Because the incident light is off-axis, the primary color distribution of the light spot is not uniform in the off-axis design.

FIG. 7 is a cross-sectional view of a bevel gradient coating dichroic mirror for the off-axis design according to an embodiment of the invention. Referring to FIG. 7, the coating film on the reflective surface 702 of the dichroic mirror has a thickness gradient or characteristic in the direction of arrow F. The arrow F is not necessarily in the horizontal direction but is depende on the direction of the incident light, for example, the direction of the lines 704, wherein the line 704 is a line indicating the incident light that has the same incident angle. By adjusting the direction of the thickness gradient or characteristic of the coating film and the distribution of the thickness or characteristic of the coating film in the direction of arrow F, the primary color distribution of the light spot can be uniform.

In a preferred embodiment of the present invention, the line 704 may be a curve.

In a preferred embodiment of the present invention, the bevel gradient dichroic film includes a dielectric material or metal.

In a preferred embodiment of the present invention, the bevel gradient dichroic film has a gradient changing film characteristic including a dielectric characteristic or a thickness of the film.

In a preferred embodiment of the present invention, the light characteristic of the light spot includes an energy distribution, a reflective index, or a light separation ratio for different color lights.

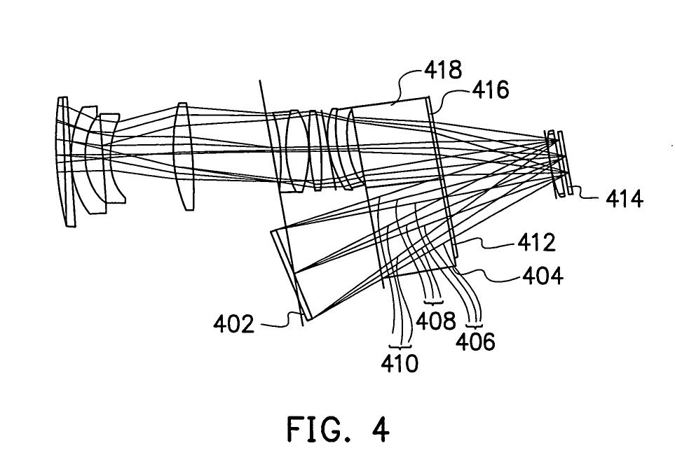

The present invention provides a liquid crystal on silicon (LCOS) display device. The LCOS display device includes, but not limited to, an off-axis LCOS display device as shown in FIG. 4.

Referring to FIG. 4, the LCOS display device includes a light source 402 for emitting a white light, a color separation mirror 404 for separating the white light to three primary color lights 406, 408, and 410, a polarizer 412 for polarizing the three primary color lights 406, 408, and 410, a liquid crystal on silicon (LCOS) panel 414 for partially polarizing the three primary color lights 406, 408, and 410 according to the video component of an input video signal, an analyzer 416, and a color recombination mirror 418. The analyzer 416 and the color recombination mirror 418 combine the partially polarized three primary color lights to obtain an output video signal. Then the output video signal is projected onto the display. The bevel gradient dichroic film of the present invention can be formed on at least one of the color separation mirror 404 and the color recombination mirror 418.

The present invention also provides a method for testing a bevel gradient dichroic film. The method including the steps of providing an incident light having a plurality of incident angles to the bevel gradient dichroic film; and testing a light characteristic of a dichroic light beam separated from the incident light at each of the incident angles to determine whether the light characteristic is uniform. In an embodiment of the invention, the method can be an incoming quality control (IQC) method.

In a preferred embodiment of the present invention, the light characteristic of the dichroic light beam includes an energy distribution, a reflective index, or a light separation ratio for different color lights.

Accordingly, in the bevel gradient dichroic film and the LCOS display device of the invention, the changing thickness gradient and characteristics of the dichroic film on the color separation mirror or color recombination mirror is dependent on the incident angle of the incident light. Therefore, by adjusting the direction of the thickness gradient or characteristic of the coating film and the distribution of the thickness or the characteristic of the coating film, the distribution uniformity, brightness, and contrast of the primary color light beams can be effectively improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1-18. (canceled)

19. A method for testing a bevel gradient dichroic film, comprising:
providing an incident light having a plurality of incident angles with respect to said bevel gradient dichroic film; and
testing a light characteristic of a dichroic light beam separated from said incident light at each said incident angles to determine whether said light characteristic has an uniform distribution.

20. The method of claim 19, wherein said light characteristic of said dichroic light beam includes an energy distribution.

21. The method of claim 19, wherein said light characteristic of said dichroic light beam includes a reflective index of a color light.

22. The method of claim 19, wherein said light characteristic of said dichroic light beam includes a light separation ratio for a color light.
